(19) United States
(12) Patent Application Publication
(10) Pub. No.: US 2005/0027581 A1
(43) Pub. Date: Feb. 3, 2005

(54) System and method for setup of meetings and conferences

(75) Inventors: Snorre Kjesbu, Slependen (NO); Thies Schrader, Haslum (NO); Hakon Dahle, Oslo (NO); Vegard Hammer, Oslo (NO)

Correspondence Address: OBLON, SPIVAK, MCCLELLAND, MAIER & NEUSTADT, P.C., 1940 DUKE STREET, ALEXANDRIA, VA, 22314, US

(73) Assignee: Tandberg Telecom AS, Lysaker (NO)

(21) Appl. No.: 10/871,026

(22) Filed: Jun. 21, 2004

(30) Foreign Application Priority Data
Jun. 20, 2003 (NO) 20032859

(51) Int. Cl. G06F 17/60

(52) U.S. Cl. 705/8

(57) ABSTRACT

A system and method for connecting one or more systems to a user for automatic determination of which system the user may use to participate in a call. A predefined list of videoconferencing systems and/or locations for each user is predefined and arranged in a prioritized order. When scheduling a meeting and/or a videoconference, the predefined user lists are taken into account when selecting end-points and other resources involved in the meeting/conference. The selection process may be controlled by predefined rules also taking various system availability, network resources and the routes required for connecting the other systems in the conference into account. The present invention also introduces presence applications to facilitate scheduling and set up of ad hoc meetings/conferences.

### CROSS-REFERENCE TO RELATED APPLICATIONS

The present application claims priority to Norwegian patent application No. 20032859, filed Jun. 20, 2003, the contents of which are incorporated herein by reference.

### DISCUSSION OF THE BACKGROUND

1. Field of the Invention

The present invention relates to managing, scheduling, and initiating videoconferences.

2. Background of the Invention

Conventional videoconferencing systems comprise a number of end-points communicating real-time video, audio, and/or data streams over and between various networks such as WAN, LAN, and circuit switched networks.

A number of videoconference systems residing at different sites may participate in the same conference, most often, through one or more MCU's (Multipoint Control Units) performing, e.g., switching functions to allow the audiovisual terminals to intercommunicate properly.

As videoconferencing involves various recourses and equipment simultaneously interoperating at different localizations and capabilities, there is a need for the possibility to manage the resources involved both for scheduled and ad hoc videoconferences. The wording schedule or scheduler shall also be understood as including setting up ad-hoc meetings or calls.

Videoconferencing systems are therefore often provided with a resource scheduler. A resource scheduler is a module that is used to schedule or book resources at any given point in time. The resource scheduler will allow a user to request resource usage at a given time, and either allow or disallow the usage at that time. Resource schedulers are often used for scheduling the use of meeting rooms, network resources, video systems, etc. The resource scheduler must be connected to a database containing updated information regarding all accessible resources like MCU's, gateways, routers, end-points, etc.

A resource scheduler may, e.g., provide system and resource overview, allowing the user to create, edit, and delete reservations, reserve resources for dial-in participants, and specify bandwidth and network settings. The resource scheduler may also support automatic call routing and automatic selection of point-to-point connections, including one or more MCU's. The resource scheduler normally operates with an intuitive web interface requiring no additional installation on the user terminal other than a conventional web browser.

Even if users have audio or videoconferencing equipment available, either as personal or group systems, a large problem with scheduling meetings using audio- and videoconferencing equipment is the lack of knowledge of which resources are available to a given participant. In many cases, it is necessary for the one that is booking the conference to ask the participants in person about which localizations and systems, etc. are accessible to them at the particular moment, and which accessories and services they have available or which are preferable. This manual “round-robin” request is added to the use of a resource scheduler, causing a delay in conference booking and reducing the utilitarian value of the resource scheduler. The lack of knowledge regarding the participants' access and preferences is also the main reason that ad-hoc conferences are difficult to set-up—they simply require too much fluctuating-knowledge from the users.

Another problem regarding ad-hoc scheduling is that even if the resource scheduler knows that a certain end-point is available and ready for use, it cannot know whether the participants are present at the different sites, when the videoconference is not pre-scheduled. Ad-hoc booking will then normally also require manual requests in the form of additional calls to the participants in advance, making it behave like a pre-scheduled call.

### SUMMARY OF THE INVENTION

It is an object of the present invention to provide a system and a method that avoids the above described problems.

The features defined in the attached claims characterize this system and method.

One aspect of the present invention discloses a system and method adapted to schedule and/or investigate possibilities for a meeting between two or more individuals and reserve associated localizations and/or facilities based on availability and/or capability, the system including a number of priority lists, one associated with each individual, respectively including a number of localizations arranged in a preferred order, a selection process adapted to select one or more localization(s) and associated facility(ies) each of which respectively included in at least one of said number of priority lists.

According to another aspect of the present invention, the system and method is further adapted to determine the availability of the localizations for each individual by means of a presence application, integrated in or connected to the system, monitoring the individuals' presence at one or more of the localizations.

According to another aspect of the present invention, there is provided a conference management system configured to attempt to schedule a meeting between two or more individuals and to reserve associated locations or facilities for the meeting based on availability, comprising: (1) one or more storage devices each configured to store a priority list, each priority list associated with an individual and including a number of locations arranged in a preferred order; and (2) a scheduler configured to select one or more locations and associated facilities, each of which is respectively included in at least one of the priority lists, wherein the facilities include conference resources configured to provide communication between the individuals if more than one location is selected, wherein the resources at least include conference end-points respectively associated with the selected one or more locations.

### BRIEF DESCRIPTION OF THE DRAWINGS

In order to make the invention more readily understandable, the discussion that follows will refer to the accompanying drawings, wherein

FIG. 1 is a block diagram showing the different elements involved in an example embodiment of the present invention;

FIG. 2 is a flow sheet illustrating the steps of a method according to one aspect of the present invention;

and

FIG. 3 is an overview of the connection between the resource scheduler, presence application, and presence server according to one embodiment of the present invention.

### DESCRIPTION OF THE PREFERRED EMBODIMENTS

In the following description, the present invention will be discussed by describing a preferred embodiment, and by referring to the accompanying drawings. However, people skilled in the art will realize other embodiments and modifications within the scope of the invention as defined in the enclosed independent claims.

The present invention introduces a novel mechanism for connecting one or more systems to a user for automatic determination of which system the user may use to participate in a call. According to an embodiment of the present invention, there is a predefined list of videoconferencing systems and/or locations for each user being arranged in a prioritized order. The list is either manually defined or generated from the user's most frequently used systems. When scheduling a meeting and/or a videoconference, these predefined user lists are taken into account when selecting end-points and other resources involved in the meeting/conference. The selection process may be controlled by predefined rules where the rules take into account the availability of various systems, as well as network resources and the routes required for connecting the other systems in the conference. The invention derives advantage from the fact that users usually have access to more than one end-point and/or meeting room, and that some accessible facilities tend to be more preferable than others. As an example, if a user has a personal video conferencing system, it would probably be the most preferable system since the user can be directly connected to that system. A group system located in the user's nearest meeting room would likely be the second most preferable system, and so on.

The utilization of prioritizing lists is further illustrated in the following example. The following users have the given lists of prioritized systems for having conferences:

User1: Personal_system_user1, Meeting_room1_site1, Meeting_room2_site1

User2: Meeting_room1_site1, Meeting_room3_site1

User3: Personal_system_user3, Meeting_room1_site2

There are many possible methods for how to select the systems used to connect the users together in a conference. One such method is based on least cost. Least cost means in this case either a selection employing as few systems as possible and/or employing routes between the systems providing the lowest costs possible. If the object is to employ as few systems as possible, assuming all systems are idle at the given time, the selection will be as follows:

Participants: User1, User3. Best system usage: Personal_system_user1 and Personal_system_user3.

Participants: User1, User2, User3. Best system usage: Meeting_room1_site1, Personal_system_user3.

Participants: User1, User2. Best system usage: Meeting_room1_site1 (no call).

If, however, the system Meeting_room1_site1 is not idle, the resource scheduler will not allow a call to be made directly to Meeting_room1_site1. The resource scheduler then sets up the conference by using all the respective personal systems.

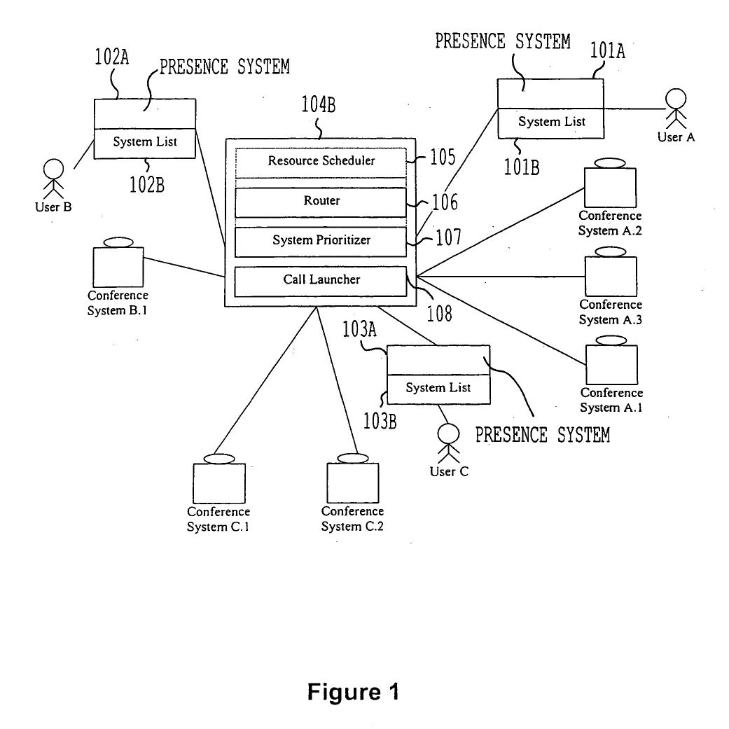

FIG. 1 illustrates an embodiment of the scheduling system of the present invention. Users A, B, and C utilize presence systems 101A, 102A, and 103A, respectively, and maintain system lists 101B, 102B, and 103B respectively.

The scheduling system includes a server 104, which contains a resource scheduler 105, a router 106, a system prioritizer 107, and a call launcher 108. The server 104 utilizes the information provided by the presence system 101A, 102A, and 103A, as well as the system lists 101B, 102B, and 103B to manage and schedule conferences, as described below.

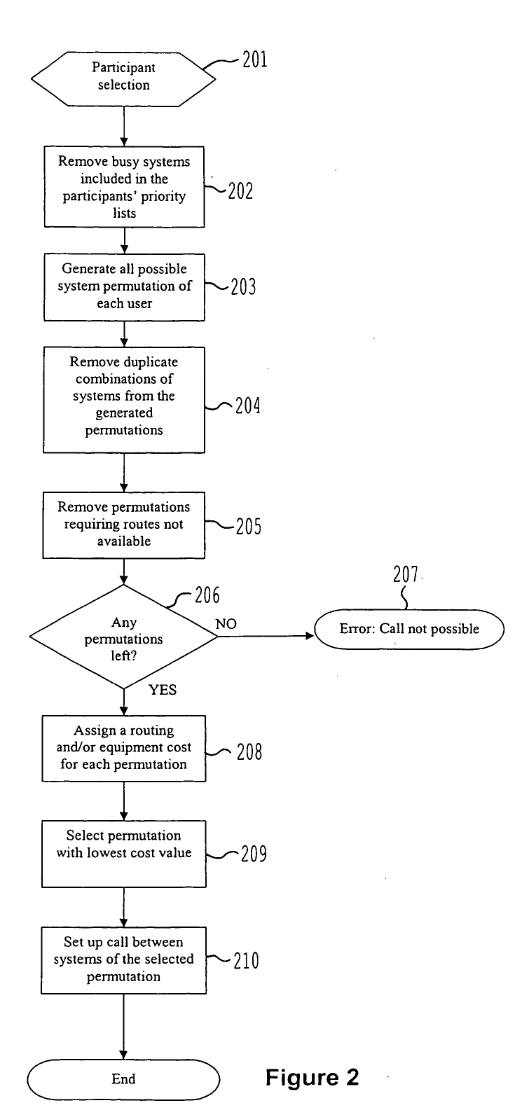

The flow diagram of FIG. 2 shows a more general overview of the steps for selecting the systems to be used in a conference call given the priority lists of the selected participants and the cost values of each system combination. The cost value is dependent upon the weighting of different factors associated with a conference call. This is exemplified with routing and/or equipment costs in the flow diagram, but other costs would also be obvious for a man skilled in the art to use.

The illustrated process starts by selecting the participants in step 201. Then, in step 202, the availability of the systems included in the selected participants' priority lists is investigated, and the ones being busy are filtered out. In step 203, all possible permutations of the remaining systems are generated for each user, and the duplicate permutations are removed in step 204.

The collection of permutations now includes all possible system constellations for the call being scheduled. Prior to further processing, it has to be checked in step 206 if the routes required for calls associated with the respective constellations are available, and those of unavailable routes are removed. If no permutations are left, an error message is handed out and the process is terminated in step 207. Otherwise, in step 208 , each available constellation is assigned one or more cost value. In step 209, the permutation with the lowest cost is determined. In step 210, the systems of this permutation are connected together in a call, and the process is terminated.

A first aspect of the present invention, i.e., reducing the need for human knowledge of user equipment when scheduling conferences and/or meetings, has just been discussed. However, the problem of not knowing the availability of the actual participants when scheduling ad-hoc conferences still remains.

The present invention includes a second aspect of introducing a presence system connected to the scheduling and accomplishment of a conference. Presence applications are known as applications indicating whether someone or something is present or not. A so-called “buddy list” on a user terminal shows the presence of the people or systems (buddies) that have been added to the list. The list will indicate if the “buddy” is present or not (logged on the computer, working, available, idle, or another status). The presence functionality creates a feeling of presence also with people or things that are located in other buildings, towns, or countries.

Presence applications are often found in conjunction with Instant Messaging (IM) applications. These applications extend the presence application by adding the possibility of exchanging information between present “buddies”. The information exchange may include applications like chat, messaging, and conferencing.

In Presence and IM applications, there is a central server keeping track of all the clients in the system, while the client provides the server with information about their own state and location. The server also handles user login, and provides information of the “buddies” in respective “buddy list” by using a proprietary protocol. However, information between clients (“buddies”) may be transmitted directly, as the server provides connection information (IP address and port number) of the client's “buddies”.

By connecting a presence or IM application to the resource scheduler, a first user will be able to see when a second user is present (not busy with something else), and at the same time, an idle system may be selected according to the priority list of the second user. This will provide a new ad-hoc possibility to common resources, as unnecessary calls (due to ignorance of presence information) will be avoided and manual negotiations through alternative communication prior to the call will not be required.

The connection between the presence application and the resource scheduler may appear for the users in many ways. The most convenient way is to integrate the resource scheduler in the IM/Presence application, or vice versa. Hence, this allows the user to see the presence of both the user and system. A double click on a “buddy” in a “buddy list” may, e.g., execute an immediate initiation of a call set up to the “buddy” using the most preferred idle system associated with the “buddy”. A click on further “buddies” preferably includes them in the call constituting a conference, all provided by the functionalities already available in the resource scheduler. The resource scheduler may be instructed by requests from the presence application using the proprietary protocol. Alternatively, all or some of the conference features available in the resource scheduler may be integrated as IM functions in the presence application. The ordinary scheduler interface will then be replaced by the GUI of the presence application initially downloaded from the server.

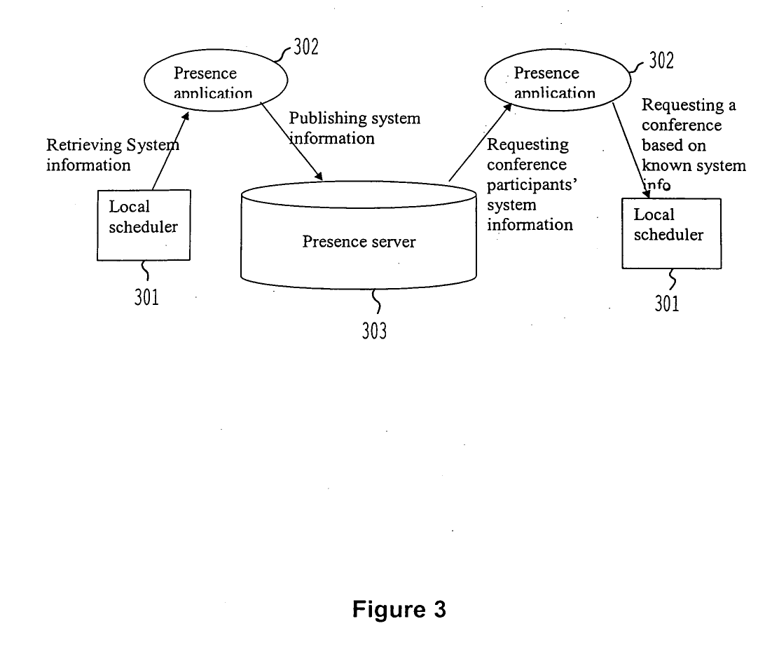

The presence application, resource scheduler, and the prioritizing mechanism may be further integrated in that the server described above is being utilized for supporting the selection procedure of the resource scheduler, as illustrated in FIG. 2. The connection between the resource scheduler, presence application, and presence server is shown in FIG. 3. Generally, the information required for the selection procedure to work has to be distributed. Such information may include system availability, qualified numbers, capabilities, usage cost, location, and priority lists. This information needs to be published to a distributed information center. According to an embodiment of the present invention, this center may be the presence server 303, as this server already stores information about the users or “buddies”. The selection procedure then utilizes the information stored in the distributed server to determine which systems to use when setting up a conference. The presence application 302 will then be responsible for maintaining system information on the server. The presence application will also request system information from the server when the user issues a conference request. The presence application will retrieve information about other participants from the server, and provide this information for the resource scheduler 301, and the resource scheduler 301 will initiate the conference with the participants from the presence application 302.

The present invention provides many advantages in connection with scheduling and the set-up of calls and conferences. As an example, a user does not need to know which systems other users can access. By means of the prioritizing mechanism, there is no need for users to know which systems to book when having a conference with a given person. With the present invention, all the user has to do is to select the person, and the system itself selects the correct system to use for that person by utilizing the associated priority list in addition to other resource availability, system capabilities, location of users, etc.

In addition, as the use of common resources often occurs in an ad-hoc fashion, the connection of presence applications and Instant Messaging with conferencing resource availability according to the present invention will create an environment to easily start ad-hoc conferences. The user no longer has to check multiple systems and persons for availability, but can just wait until a user with a compatible system is available, and click “conference”.

Also, by the introduction of presence and IM applications, initiating a call with another user or including a user in an already established conference, will be easy and intuitive by simply double clicking on the link of the wanted and present user included in the “buddy list” of the presence or IM application.

1. A conference management system configured to attempt to schedule a meeting between two or more individuals and to reserve associated locations or facilities for the meeting based on availability, comprising:
one or more storage devices each configured to store a priority list, each priority list associated with an individual and including a number of locations arranged in a preferred order;
a scheduler configured to select one or more locations and associated facilities, each of which is respectively included in at least one of the priority lists, wherein the facilities include conference resources configured to provide communication between the individuals if more than one location is selected, wherein the resources at least include conference end-points respectively associated with the selected one or more locations.

2. The conference management system of claim 1, wherein the scheduler is configured to minimize a total cost derived from a number of cost values assigned to the locations and facilities when selecting among said cost values.

3. The conference management system of claim 2, wherein each location is assigned a cost value according to priority within the respective priority lists.

4. The conference management system of claim 1, wherein the scheduler is configured to minimize the one or more locations included in the meeting.

5. The conference management system of claim 1, wherein the scheduler is configured to filter out occupied locations and facilities.

6. The conference management system of claim 1, wherein said conference resources further include one or more communication routes, one or more Gateways, or one or more Multiple Conference Units.

7. The conference management system of claim 2, wherein said cost values respectively represent at least one of bandwidth capabilities, WAN capabilities, LAN capabilities, and routing costs.

8. A conference management system configured to attempt to schedule a meeting between two or more individuals and to reserve associated locations or facilities for the meeting based on availability or capability information, comprising:
a scheduler configured to determine availability of the locations or facilities for each individual by means of (1) a presence application, integrated into or connected to the system, the presence application configured to monitor a presence of each individual at one or more of the locations, and (2) the availability of the respective facilities.

9. A conference management system according to claim 8, further comprising:
one or more storage devices configured to store priority lists, each priority list associated with an individual and including a number of locations arranged in a preferred order,
wherein the scheduler is configured to select one or more locations and associated facilities, each of which is respectively included in at least the priority lists associated with present individuals, and
the facilities include conference resources configured to provide communication between the individuals if more than one location is selected, wherein the resources at least include conference end-points respectively associated with the selected one or more locations.

10. The conference management system of claim 9, wherein the scheduler is configured to allow selection of individuals to participate in the meeting from a “buddy” list provided by said presence application.

11. The conference management system of claim 8, wherein said presence application is supported by a central presence server at least providing presence information for each individual.

12. The conference management system of claim 9, wherein the selection process is adapted to minimize a total cost derived from a number of cost values assigned to the locations and facilities when selecting among said cost values.

13. The conference management system of claim 9, wherein each location is assigned a cost value according to priority within the respective priority lists.

14. The conference management system of claim 9, wherein the scheduler is configured to minimize the one or more locations included in the meeting.

15. The conference management system of claim 9, wherein said conference resources further include one or more communication routes, one or more Gateways, or one or more Multiple Conference Units.

16. The conference management system of claim 13, wherein said cost values respectively represent bandwidth at least one of capabilities, WAN capabilities, LAN capabilities, and routing costs.

17. The conference management system of claim 12, further comprising:
a supporting scheduler server configured to store said priority lists and said number of cost values in addition to the availability and capability information of the locations and the facilities.

18. The conference management system of claim 12, wherein said presence server further stores said priority lists and said number of cost values in addition to the availability and capability information of the localizations and the facilities.

19. A method for attempting to schedule a meeting between two or more individuals and to reserve associated locations or facilities for the meeting based on availability or capability information, comprising:
selecting one or more locations and associated facilities, each of which is respectively included in at least one priority list, each priority list stored in one or more storage devices associated with an individual and including a number of locations arranged in a preferred order,
wherein the facilities include conference resources adapted to provide communication between the individuals if more than one location is selected; and
said resources at least include conference end-points respectively associated with the selected one or more locations.

20. The method of claim 19, further comprising:
minimizing a total cost derived from a number of cost values assigned to the locations and facilities when selecting among said cost values.

21. The method of claim 20, further comprising:
assigning a cost value according to priority within the respective priority lists to each location.

22. The method of claim 19, further comprising:
minimizing the one or more locations included in the meeting.

23. A method for attempting to schedule a meeting between two or more individuals and to reserve associated locations or facilities for the meeting based on availability or capability information, comprising:
determining availability of the locations or facilities for an individual by means of a presence application, and;
monitoring presence of the individual at one or more of the locations and the availability of the respective facilities.
